(19) United States
(12) Patent Application Publication
(10) Pub. No.: US 2025/0060469 A1
(43) Pub. Date: Feb. 20, 2025

(54) PHASE-BASED RANGING USING DISPERSED CHANNELS

(71) Applicant: NORDIC SEMICONDUCTOR ASA, Trondheim (NO)

(72) Inventor: Daniel James RYAN, Trondheim (NO)

(21) Appl. No.: 18/719,018

(22) PCT Filed: Dec. 13, 2022
(86) PCT No.: PCT/EP2022/085611

§ 371 Date: Jun. 12, 2024

(30) Foreign Application Priority Data
Dec. 14, 2021 (NO) 20211506

(51) Int. Cl. G01S 13/10; G01S 7/285

(52) U.S. Cl. CPC G01S 13/103; G01S 7/285; G01S 13/106

(57) ABSTRACT

Radio transceiver device and method are provided. The method includes sequentially transmitting radio frequency signals on radio channels, each channel being nonuniformly spaced and representing a distinct continuous tone, sequentially transmitting radio frequency signals with distinct continuous tones on same channels as those received from the first radio transceiver device, as well as measured phase difference of the radio frequency signals on each radio channel received from the first radio transceiver device, creating a first set of estimate candidates, repeatedly for the radio channels, determining an optimal phase unwrapping vector candidate based on the first set of estimate candidates and the measured phase differences of signals received on the first and second transceiver devices to determine a second set of candidates, and calculating the distance between the first and second radio transceiver devices using the optimal phase unwrapping vector candidate and the second set.

The present invention relates to methods for determining a distance between a first radio frequency devices and a second radio frequency device, and to a radio frequency transceiver device performing the methods.

### BACKGROUND AND PRIOR ART

It is often useful to estimate the distance between two communicating radio frequency nodes. For instance, estimating the distance between two radio frequency devices can be useful for triggering proximity-based actions on one or both of the devices (e.g. to trigger an alert if two devices become too close or too far from one another). This distance can be determined by analysing radio frequency signals traveling between the two nodes.

Conventional approaches to distance estimation using RF signals involve phase based ranging techniques, in which a first radio frequency device, referred to as an initiator, transmits a constant tone using a local oscillator (LO). The second radio frequency device, referred to as a reflector, who has a local oscillator (LO) at the same frequency as the first frequency device measures a first phase difference ψᵢᵣ, between its LO and the constant tone. Then the roles are switched, and reflector sends a constant tone, while the initiator measures a second phase difference ψᵣᵢ. The sum of the two phase-differences is related to the distance between the first radio frequency device and the second radio frequency according to

$$ψ ( f ) = {ψ}_{ir} ( f ) + {ψ}_{ri} ( f ) \approx \frac{4 π fd}{v}$$

where f is the shared LO frequency, v is the speed of light in the medium.

By taking phase measurements over at least two frequencies, e.g. f₁, f₂ it is possible to determine the distance according to:

$$d = \frac{v ( ψ ( {f}_{1} ) - ψ ( {f}_{2} ) )}{4 π ( {f}_{1} - {f}_{2} )}$$

In order to improve the quality of the distance estimate in the presence of phase error, phase measurements are performed on all possible channels within a frequency band, and the distance is determined using a linear regression solving for the slope of the phase difference as a function of f.

However, due to phase wrapping the determined distance has infinite possible solutions

$$d = \frac{v ( ψ ( {f}_{1} ) - ψ ( {f}_{2} ) )}{4 π ( {f}_{1} - {f}_{2} )} + \frac{vk}{2 ( {f}_{1} - {f}_{2} )}$$

where k is any integer, which for a 2 MHz channel spacing leads to an ambiguity of multiples of 75 m from the real distance. Thus, with uniform spaced measurements it is limited how far apart it is possible to separate channels as this reduces the maximum resolvable range of the system. However, the frequencies should be separated as far as possible to reduce the influence of the phase estimation error on the distance which scales by l(f₁−f₂) as shown above. Determining the slope of the phase difference as a function of f requires correct phase unwrapping of the data. Correct phase unwrapping is difficult if phase measurements are missing for certain frequencies or have been corrupted by RF interference.

Phase measurements may be missing for various reasons, such as packet loss due to interference, when using channel hopping schemes, such as the pseudo-random schemes used in Bluetooth Low Energy (BLE), or when protocols restrict use of certain frequencies, such as BLE primary advertising channels. Furthermore, even in the absence of ambiguity and phase unwrapping error, it is desirable to have the slope estimation performed over frequencies as widely separated as possible to provide improved accuracy, but with fewest frequencies as possible to provide minimum measurement latency and energy consumption.

In view of the above it is desirable to provide a method for determining a distance between a first radio frequency devices and a second radio frequency device, and a radio frequency transceiver device, that solves or at least mitigates one or more of the aforementioned problems related to determining the distance between two radio frequency devices.

### SUMMARY OF THE INVENTION

In a first aspect, the invention provides method for determining a distance between a first radio transceiver device and a second radio transceiver device, the method comprising:
sequentially transmitting, from the first radio transceiver device to the second radio transceiver device, radio frequency signals on a plurality of radio channels, each channel being non-uniformly spaced and representing a distinct continuous tone,
sequentially transmitting, from the second radio transceiver device to the first radio transceiver device, radio frequency signals with distinct continuous tones on same channels as those received from the first radio transceiver device, as well as measured phase difference of the radio frequency signals on each radio channel received from the first radio transceiver device, on the first radio transceiver device:
creating a first set of estimate candidates,
repeatedly for the plurality radio channels, determining an optimal phase unwrapping vector candidate based on the first set of candidates and the measured phase differences of signals received on the first and the second transceiver devices to determine a second set of candidates, and
calculating the distance between the first radio transceiver device and the second radio transceiver device using the optimal phase unwrapping vector candidate and the second set of candidates.

Measuring on non-uniformly spaced channels mitigates problems with measurements on uniform spaced channels, such as limitations on how far it is possible to separate channels for reducing the influence of the phase estimation error on the calculated distance. The method for determining the distance between two radio transceiver devices is tolerant to missing phase measurements. Thus the method is applicable for use in situations where phase measurements is missing, such as packet loss due to interference, when using channel hopping schemes, such as the pseudo-random schemes used in Bluetooth Low Energy (BLE), or when protocols restrict use of certain frequencies, such as BLE primary advertising channels.

In one embodiment, the plurality of radio channels may be a subset of a frequency band comprising of uniformly spaced radio channels.

As the method is tolerant to missing phase measurements, the method only requires to perform phase measurements on a subset of the frequency band, such that distance estimation is performed over frequencies as widely separated as possible to improve accuracy, but with fewest frequencies as possible to provide minimum measurement latency as well as reducing power consumption of the radio transceiver devices.

In one embodiment, the first set of estimate candidates and the second set of candidates comprises candidates of the distance between the first radio transceiver device and the second transceiver device. Thus, the distance between the two radio transceiver devices may be estimated from a limited number of phase measurement.

In one embodiment, the first set of estimate candidates and the second set of candidates may comprise candidates of a time offset between the first radio transceiver device and the second transceiver device, and the step of calculating the distance between the first radio transceiver device and the second radio transceiver device may further comprising
calculating the time offset between the first radio transceiver device and the second transceiver device using the optimal phase unwrapping vector candidate and the second set of time offset candidates, and
on the second radio transceiver device, determining the distance between the first radio transceiver device and the second transceiver device by measuring the phase difference of the radio frequency signals on each radio channel received from the second radio transceiver device on a superset of the plurality of radio channels used to calculate the time offset.

In this manner the time-offset between the two radio transceiver devices may be estimated from a limited number of phase measurement, and the time-offset may be used so that the rest of phase measurements are one way measurements, thus reducing power consumption of the radio transceiver devices.

In one embodiment, the superset of the plurality of radio channels used to calculate the time offset may comprise the frequency band comprising of uniformly spaced radio channels. The frequency band may comprise 75 radio frequencies uniformly spaced at 1 MHz or 37 radio frequencies spaced at 2 MHz.

In a second aspect, the invention provides radio frequency transceiver device arranged to
sequentially transmit radio frequency signals on a plurality of radio channels, each channel being non-uniformly spaced and representing a distinct continuous tone,
sequentially receive from a second radio transceiver device, radio frequency signals with distinct continuous tones on same channels as those transmitted from the first radio transceiver device, as well as measured phase difference of the radio frequency signals on each radio channel transmitted from the first radio transceiver device,
create a first set of estimate candidates, repeatedly for the plurality of radio channels, determine an optimal phase unwrapping vector candidate based on the first set of candidates and the measured phase differences of signals received on the first and the second transceiver devices to determine a second set of candidates, and
calculate the distance between the first radio transceiver device and the second radio transceiver device using the optimal phase unwrapping vector candidate and the second set of candidates.

The second aspect of the invention and the embodiments thereof provides the same advantages as the embodiment of the first aspect of the invention.

In one embodiment of the second aspect, the plurality of radio channels may be a subset of a frequency band comprising of uniformly spaced radio channels.

In one embodiment the second aspect, the first set of estimate candidates and the second set of candidates may comprise candidates of the distance between the first radio transceiver device and the second transceiver device.

In one embodiment the second aspect, the first set of estimate candidates and the second set of candidates may comprise candidates of a time offset between the first radio transceiver device and the second transceiver device, the step of calculating the distance between the first radio transceiver device and the second radio transceiver device may further comprising:
calculating the time offset between the first radio transceiver device and the second transceiver device using the optimal phase unwrapping vector candidate and the second set of time offset candidates, and
on the second radio transceiver device, determining the distance between the first radio transceiver device and the second transceiver device by measuring the phase difference of the radio frequency signals on each radio channel received from the second radio transceiver device on a superset of the plurality of radio channels used to calculate the time offset.

In one embodiment of the second aspect, the superset of the plurality of radio channels used to calculate the time offset may comprise the frequency band comprising of uniformly spaced radio channels. The frequency band may comprise 75 radio frequencies uniformly spaced at 1 MHz or 37 radio frequencies spaced at 2 MHz.

### BRIEF DESCRIPTION OF THE DRAWINGS

Following drawings are appended to facilitate the understanding of the invention. The drawings show embodiments of the invention, which will now be described by way of example only, where:

FIG. 1 is a schematic illustration of an arrangement for use in embodiments of the present invention;

FIG. 2 is a flow diagram illustrating a method according to an embodiment of the present invention;

FIGS. 3, 4 and 5 shows simulated results of distance estimation of embodiments of the present invention; and

FIG. 6 is a flow diagram illustrating a method according to an embodiment of the present invention

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

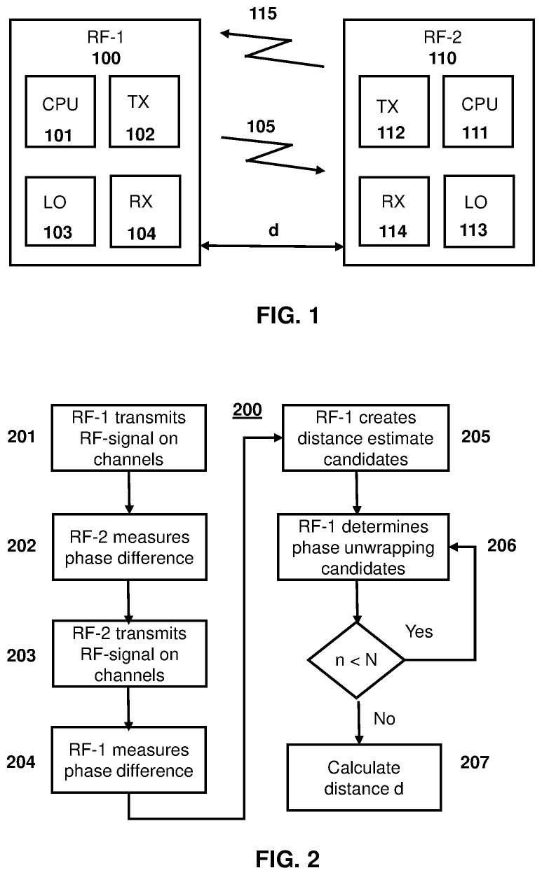

FIG. 1 shows a first radio frequency (RF) device (RF-1) 100 and a second radio frequency (RF) device (RF-2) 110, separated by a distance d. The first RF device 100 comprises an RF transmitter (TX) 102, an RF receiver (RX) 104, a local oscillator (LO) 103 and a processor (CPU) 101 in communication with the RF-transmitter 102, the RF-receiver 104 and the LO 103. The first RF-device 100 is in the following referred to as a first radio transceiver device 100. The second RF device 110 comprises an RF transmitter (TX) 112, an RF receiver (RX) 114, a local oscillator (LO) 113 and a processor (CPU) 111 in communication with the RF-transmitter 112, the RF-receiver 114 and the LO 113. The second RF-device is in the following referred to as a second radio transceiver device 110.

In use, the transmitter 102, of the first radio frequency transceiver 100 sequentially transmits radio frequency signals 105 on a plurality of radio channels. Each radio channel being defined by a carrier frequency. The radio frequency signals 105 are received by the receiver 114 of the second radio frequency transceiver device 110. The transmitter 112 of the second radio frequency transceiver device 110 sequentially transmits radio frequency signal 115 on the plurality of radio channels. The radio frequency signals 115 are received by the receiver 104 of the first radio transceiver device 100. The received radio frequency signal 105, 115 is used to estimate the distance d between the first and second radio transceiver devices 100, 110, as described in more detail with reference to FIG. 2.

A method 200 of determining the distance, d, between the first radio transceiver device 100 and the second radio transceiver device 110 will now be described with reference to FIG. 2.

In this example, in step 201, the first radio transceiver device 100, sequentially transmits, from the first radio transceiver device 100 to the second radio transceiver device 110, radio frequency signals 105 on a plurality of radio channels. Each channel is non-uniformly spaced and representing a distinct continuous tone. The second radio transceiver device 110, in step 202, measures (e.g. using the processor 111) the phase difference of the radio frequency signals 105 on each radio channel received from the first radio transceiver device 100. The second radio transceiver device 110, in this configuration referred to as the reflector, measures the phase difference ψᵢᵣ, between its LO 113 and the received radio frequency signal 105. The distinct continuous tone of the received radio frequency signal is generated by the LO 103 of the first radio transceiver device 100. Both LO's 103, 113 are set to the same frequency.

The plurality of radio channels may be a subset of a frequency band comprising of uniformly spaced radio channels. The frequency band comprising of uniformly spaced radio channels may be defined as f=f₀+nΔf, where n is an integer, signifying the channel number, and Δf is the channel spacing. In one embodiment of the present invention, non-uniformly spaced channels are selected by choosing random integers n in a non-linear sequence, such as n=4, 51, 78.

The frequency band comprising of uniformly spaced radio channels may for example comprise 75 radio frequencies uniformly spaced at 1 MHz such as for Bluetooth, or 37 radio frequencies spaced at 2 MHz, such as for Bluetooth Low Energy (BLE). In an exemplary embodiment, f₀=2400 MHZ, Δf=1 MHz and n=4, 51, 78, then the three frequencies in use are 2404, 2451 and 2478 MHz.

In step 203, the second radio transceiver device 110, i.e. the second radio transceiver device 110, sequentially transmits, from the second radio transceiver device 110 to the first radio transceiver device 100, radio frequency signals 115 with distinct continuous tones on same channels as those received from the first radio transceiver device 100. The second radio transceiver device 110 also transmits the measured phase difference of the radio frequency signal 105 on each radio channel received from the first radio transceiver device, i.e. ψᵢᵣ(f). The measurement may be transmitted over a separate datalink or via modifying the phase of the reflected signal.

In step 204, the first radio transceiver device 100, measures (e.g. using the processor 101) the phase difference of the radio frequency signals 115 on each radio channel received from the second radio transceiver device 110. The first radio transceiver device 100, in this configuration referred to as the initiator, measures the phase difference ψᵣᵢ, between its LO 103 and the received radio frequency signal 115. The distinct continuous tone of the received radio frequency signal is generated by the LO 113 of the second radio transceiver device 110. Both LO's 103, 113 are set to the same frequency, which are locked for each device 100, 110 during these steps.

The relative phase between signal paths is described above a function of the distance travelled between the first and second radio transceiver devices 100, 110. In addition, there may be an additional phase offset for each frequency, reflecting the delay of the radio signal chain, that may be calibrated to an offset constant over each RF frequency.

The signal received at the second radio transceiver device 110, i.e. the reflector, is then given by

$${y}_{r} ( n ) = {\sum }_{l = 1}^{L} h ( {d}_{l} ) exp j ( \frac{2 π ( {f}_{0} + n Δ f ) {d}_{l}}{v} ) exp j ( {θ}_{i} ( n ) - {θ}_{r} ( n ) + {ψ}_{ir , 0} ) + {v}_{r} ( n )$$

where h(dₗ) is the real-valued amplitude of the lth path at distance dₗ; θᵢ(n), θᵣ(n) is the phase of the initiator LO 103 and reflector LO 104 respectively, ψ_{ir,0} is a constant phase offset common to each of the second radio transceiver 110 measurements, and vᵣ(n) is a noise term. Similarly, the signal received at the first radio transceiver device 100, i.e. the initiator, is given by

$${y}_{i} ( n ) = {\sum }_{l = 1}^{L} h ( {d}_{l} ) exp j ( \frac{2 π ( {f}_{0} + n Δ f ) {d}_{l}}{v} ) exp j ( {θ}_{r} ( n ) - {θ}_{i} ( n ) + {ψ}_{ri} , 0 ) + {v}_{i} ( n )$$

where ψ_{ri,0} is a constant phase offset common to each of the first radio transceiver 100 measurements, and vi (n) is a noise term. The resulting relative phase is given by
ψ(n)=∠yᵣ(n)yᵢ(n), which gives:

$$ψ ( n ) = ∠ [ ( {\sum }_{k = 1}^{K} {\sum }_{l = 1}^{L} h ( {d}_{k} ) h ( {d}_{l} ) exp ( \frac{2 π ( {f}_{0} + n Δ f ) ( {d}_{l} + {d}_{k} )}{v} ) ) + η ( n ) ] + {ψ}_{0}$$

where η(η) is a noise term and ψ₀=ψᵢᵣ+ψᵣᵢ.

The inventor has realized that the method of the present invention may resolve the strongest path even if another strong path is relatively close. It may be assumed that there is a single path and the above equation may be simplified to

$$ψ ( n ) = {mod [ \frac{4 π ( {f}_{0} + n Δ f ) d}{v} + {ψ}_{0} + ξ ( n ) ]}_{2 π}$$

where mod[·]_{γ} is the modulo function with a range [0, γ), ψ₀ is a system independent constant, ξ(n) is the phase measurement error. Therefore, for a set of values of N values of n, this may be written in vector form as

$$ψ = {[ \frac{4 π Δ fd}{v} n + ( \frac{4 π {f}_{0} d}{v} + {ψ}_{0} ) 1 + ξ ]}_{2 π}$$

where ψ∈ [symbol] ^{N×1} is the vector of phase measurements, n∈ [symbol] ^{N×1} is the vector of channel numbers, 1∈ [symbol] ^{N×1} consists of all 1's, and ξ.

Defining θ=ω/(2π), ζ=ξ/(2π) α=2Δfd/v and

$$θ = {[ α n + β 1 + ξ ]}_{1}$$

the above equation may be written as

$$β = \frac{2 {f}_{0} d}{v} + {ψ}_{0} / 2 π ,$$

Defining a metric

$${M}_{1} ( α , β , p ) = {‖ α n + β 1 - p - θ ‖}^{2}$$

then finding the distance estimate may be performed by solving

$$\hat{α} = {arg min}_{α} {min}_{β ∈ ℝ , \tilde{p} ∈ {ℤ}^{N}} {‖ α n + β1 - p - θ ‖}^{2}$$

and then solving for

$$\hat{d} = \frac{\hat{α} v}{2 Δ f} .$$

The expression may be minimized as a function of β giving

$$\hat{β} = - \frac{1 \cdot ( α n - p - θ )}{N}$$

Inserting this equation back into the previous equation gives

$${M}_{2} ( α , \tilde{p} ) = {M}_{1} ( α , \hat{β} , p ) = {‖ α \tilde{n} - \tilde{θ} - \tilde{p} ‖}^{2} \\ where \\ \tilde{n} = n - \frac{( {1}^{T} n )}{N} 1 , \\ \tilde{p} = p - \frac{( {1}^{T} p )}{N} 1 , \\ and \\ \tilde{θ} = θ - \frac{( {1}^{T} θ )}{N} 1$$

A lattice A_{N-1}* is defined as the set of points in [symbol] ^{N} as

$${A}_{N - 1}^{*} = \{ \tilde{z} = z - \frac{( {1}^{T} z )}{N} 1 \vert z ∈ {ℝ}^{N} \} .$$

The distance estimate above may then be rewritten as

$$\hat{a} = \begin{matrix}arg min \\ α\end{matrix} \begin{matrix}min \\ \tilde{p} ∈ {A}_{N - 1}^{*}\end{matrix} {M}_{2} ( α , \tilde{p} )$$

This is equivalent to, for each possible value of a, finding the closest lattice point \tilde{p} to the point αñ−\tilde{θ}.

In step 205, the first radio transceiver device 100 creates a first set of distance estimates candidates

$${D}_{1} = \{ m δ + {δ}_{0} \vert m ∈ ℤ , 0 < m < v / ( 2 Δ f δ ) \}$$

which leads to a set of corresponding a values

$${A}_{1} = \{ 2 Δ fd / v \vert d ∈ {D}_{1} \}$$

Then for each distance estimate candidate d̅∈D₁, there is a corresponding candidate of α in A₁, α̅.

Then in step 206, the first radio transceiver device 100, repeatedly for the set of measured phase differences values of N values of n plurality radio channels, determines an optimal phase unwrapping candidate based on the first set of distance candidates D₁ and the measured phase differences of signals received on the first and the second transceiver devices to determine a second set of distance candidates D₂. Step 206 may be performed using the following calculation steps:

An optimal value for the vector p, i.e. the unwrapping vector, may be obtained by

$$\hat{p} ( \overline{α} ) = \begin{matrix}arg min \\ \tilde{p} ∈ {A}_{N - 1}^{*}\end{matrix} ‖ \overline{a} \tilde{n} - \tilde{θ} - \tilde{p} ‖ , \overline{α} ∈ {A}_{1}$$

Then, for each value of \hat{p}(α̅) a new optimal value of α is calculated by solving for

$$\frac{\partial {M}_{2} ( α , \tilde{p} )}{\partial α} = 0 ,$$

that after some algebraic manipulation gives

$$\frac{\partial {M}_{2} ( α , \tilde{p} )}{\partial α} = {( \tilde{θ} + \tilde{p} )}^{2} - 2 \overline{α} {\tilde{n}}^{T} ( \tilde{θ} + \tilde{p} ) + {\overline{α}}^{2} {\tilde{n}}^{T} \tilde{n}$$

and in turn gives

$$\hat{α} ( \overline{α} ) = \frac{{\tilde{n}}^{T} ( \tilde{θ} + \hat{p} ( \overline{α} ) )}{{\tilde{n}}^{T} \tilde{n}}$$

This leads to a new set of α candidates:

$${A}_{2} = \{ \hat{α} ( \overline{α} ) \vert \overline{α} ∈ {A}_{1} \}$$

and a corresponding set of distance candidates:

$${D}_{2} = \{ α v / ( 2 Δ f ) \vert d ∈ {D}_{1} \}$$

Then in step 207, the distance d, i.e. d̅, between the first radio transceiver device 100 and the second radio transceiver device 110 is calculated using the optimal phase unwrapping candidate and the second set of distance candidates. Step 207 may be performed using the following calculation steps

A third metric M₃(α̅) is defined using these values:

$${M}_{3} ( \overline{α} ) = {‖ \hat{α} ( \overline{α} ) \tilde{n} - \tilde{θ} - \hat{p} ( \overline{α} ) ‖}^{2} ,$$

Then all M₃(α̅) is minimized for all ã∈A₁, to obtain the optimal value of a, i.e.,

$$\overline{\overline{a}} = \begin{matrix}arg min \\ \overline{α} ∈ {A}_{1}\end{matrix} {M}_{3} ( \overline{α} )$$

which is used to obtain the distance estimate.

$$\overline{\overline{d}} = \frac{v \overline{\overline{α}}}{2 Δ f} .$$

The above method describes distance estimation using two-way ranging (2WR), where both radio transceiver devices 100, 110, e.g. initiator and reflector, send tones and performs measurements.

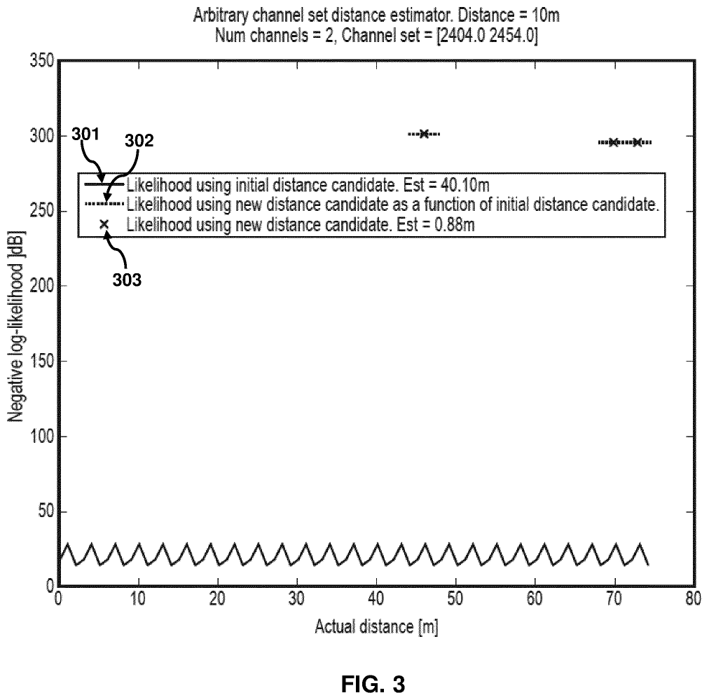

FIGS. 3, 4 and 5 shows simulated results of distance estimation of embodiments of the present invention. The data set used for the simulation is a BLE data channel set consisting of the channels 2400+n*2 MHz where n=1, 2, 3, . . . , 20, however the BLE primary advertising channels 2402, 2426 and 2480 MHz are excluded. For each BLE channel used, the initiator and receiver send a continuous wave at the channel frequency. The initiator and reflector are separated by a distance of 10 m. To simulate phase estimation error, a random error of −15°, 0°, 15°. is applied to the values of ψ(n). For calculating the metrics, the first set of distance estimate candidates, D1, is defined as follows

$${D}_{1} = \{ m + 0.1 \vert m ∈ ℤ , 0 < m < 75 \}$$

In a first step of the simulation, two distinct random channels are chosen from the BLE data channel set. A phase measurement is performed on each channel and then a distance estimate is performed using the method of the present invention. Then in the next steps of the simulation, additional random channels is chosen, distinct from the previously chosen channels, and a new phase measurements is performed. Each channel is selected such that the vector n has a lowest common divisor of 1, otherwise there would be multiple solutions for a. This may be done by for example, regenerating the channel sequence by a common seed for the radio transceiver devices until a set of channels with lowest common divisor of 1 is found. Alternatively, a random sequence of minimum length may be generated, and channels added until a set of channels with lowest common divisor of 1 is found.

FIGS. 3, 4 and 5 demonstrates the likelihood and resulting distance estimate values calculated in each step of the method of the present invention. The solid lines 301, 401, 501 are plots of the values of 10 log₁₀ M₂(α, \hat{p}(α̅)) as a function of d̅∈D₁. Then for each value of d̅∈D₁, the values of M₃(α̅) that were obtained using the values of \hat{p}(α̅), are plotted 302, 402, 502 as a function of d̅∈D₁. Further, the values of M₃(α̅) are plotted 303, 403, 503 as a function of d̅∈D₂.

FIG. 3 shows the result for N=2. Gaps in the plot are a result of that for N=2, the optimal has an exact solution, and therefore are actually 0. The plotted values are due to computational rounding error. The distance between the frequencies in this simulation is 50 MHz, and therefore there exists a periodicity in M₂(α, \hat{p}(α̅)) of

$$\frac{v}{2 Δ f} = \frac{3 \times {10}^{8}}{2 \times 50 \times {10}^{9}} = 3 m . ,$$

shown in the plot. The initial distance candidate is 40.10 m and the new distance estimate 0.88 m.

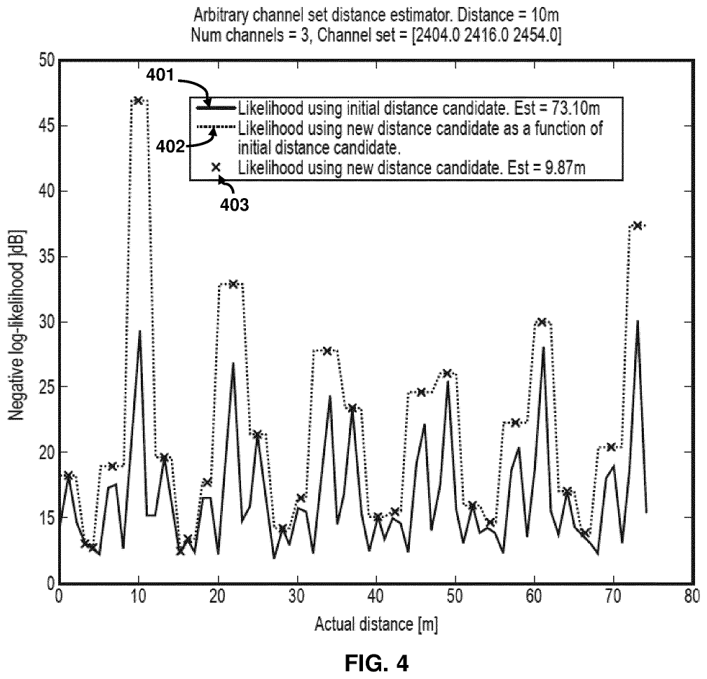

FIG. 4 show the result for N=3. The initial M₂(α, \hat{p}(α̅)) metric produces several peaks, but the best likelihood is achieved at a distance of 73.10 m. However, for M₃(α̅), where the distance candidates have been recalculated, a good value is found of 9.87 m, which is close to the simulated distance of 10 m.

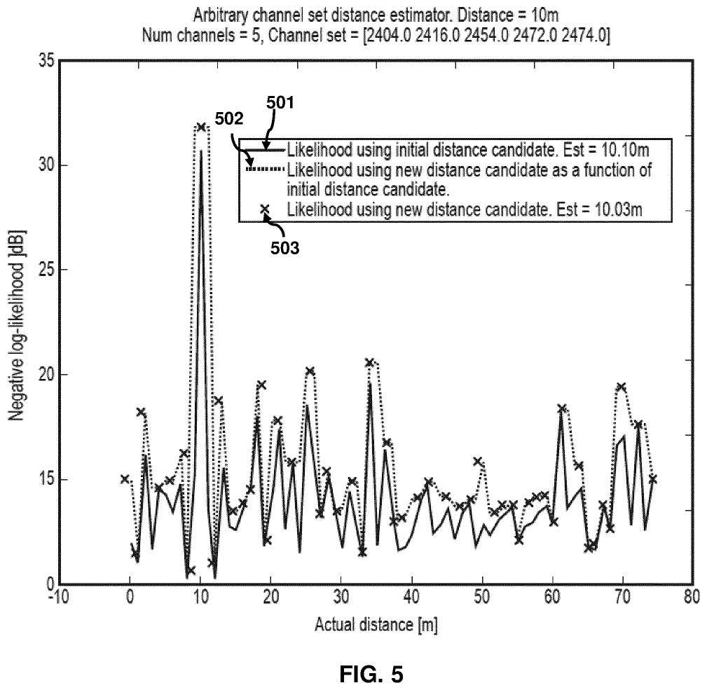

FIG. 5 show the result for N=5, where both the initial distance candidate (10.10 m) and the new distance candidate (10.03) is very close to the simulated distance of 10 m.

This illustrates that using the method of the present invention only a handful of frequencies, 3-5 are required to achieve a good estimate of the distance between two radio transceiver devices.

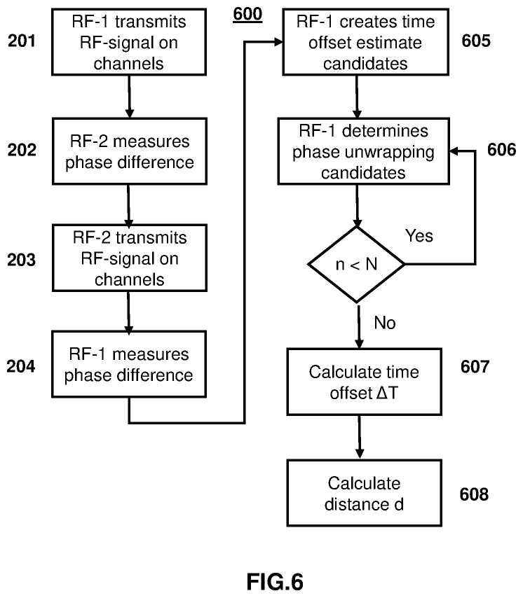

An alternative method 600 of 2WR is asymmetric 2WR, where for a subset of the tones, the tones are sent in two directions is illustrated in FIG. 6. One way ranging (1WR) utilizes knowledge of a time offset ΔT, between the two radio transceiver devices, 100, 110, to determine the distance, d, between the two radio transceiver devices, 100, 110. For example, the first radio transceiver device 100, i.e. initiator, may transmit tones on 70 channels, where for only 5 of those channels the second radio transceiver device 110, i.e. the reflector, transmitted a tone first, which the first radio transceiver device 100 responded to. The alternative method 600 performs steps 201-204 as described above with reference to FIG. 2, on the subset of the tones that are sent in two directions.

When the first and second radio transceiver devices 100, 110, exhibit phase coherence, i.e. the phase of the transmitted and signal is predictable over all frequency hops, then these 5 channels can be used to resolve the time offset ΔT. The time offset ΔT may then be used to determine the distance, d, between the two radio transceiver devices, 100, 110, using regular 1WR methodologies by calculating the distance estimate directly from the values of ψᵢᵣ(f) or ψᵣᵢ(f) as described below.

$$Given that {ψ}_{ir} ( f ) = - 2 π f ( \frac{d}{v} + Δ T ) and {ψ}_{ri} ( f ) = - 2 π f ( \frac{d}{v} - Δ T )$$

Then we can write

$$θ ( f ) = {ψ}_{ir} ( f ) - {ψ}_{ir} ( f ) = - 4 π f Δ T$$

Thus, the distance, d, between the two radio transceiver devices, 100, 110, can by calculated directly from the values of ψᵢᵣ(f) or ψᵣᵢ(f) when the value of ΔT is constant over the duration of an event. Constant ΔT can be obtained by precise timing of frequency shifts, e.g. by ensuring the LO phase is shifted by the same amount on both the first radio transceiver device and the second radio transceiver device at the start of each step. For example, by ensuring that the phase is continuous between steps. In addition, any frequency offset Δf between the first and second transceiver devices, 100, 110, for each frequency should be known and corrected for.

The frequency offset may be observed as each RF frequency is derived from a common source, e.g. a crystal oscillator. This may result in a frequency offset given by FFO*f, where FFO is the fractional frequency offset of the crystal oscillator.

Within any step, the effect of the frequency offset of the radio transceiver devices causes both a phase offset in the reflector measurement and the initiator measurement.

The effect of the frequency offset Δf=fᵢ−fᵣ results in a phase error at the reflector Δϕ_{R}. This error is given by

$${Δϕ}_{R} = 2 πΔ f \cdot \frac{1}{{T}_{PM}} {\int }_{0}^{{T}_{PM}} tdt = 2 πΔ f \cdot \frac{1}{{T}_{PM}} \cdot \frac{{T}_{PM}^{2}}{2} = πΔ f \cdot {T}_{PM} .$$

The tone sent by the reflector comes at a time, T_{D}, after the start of the tone sent by the initiator. This may be denoted as the dwell-time. This results in a time difference in the center of both phase measurements, i.e. the dwell time T_{D}=N_{AP}T_{PM}+T_{RD}+T_{lP1}. At the initiator, the phase error at the reflector, Δϕₗ, is therefore given by

$${Δϕ}_{I} = 2 π ( - Δ f ) \frac{1}{{T}_{PM}} {\int }_{{T}_{D}}^{{T}_{D} + {T}_{PM}} tdt = - \frac{2 πΔ f}{2 {T}_{PM}} \cdot ( {T}_{D}^{2} + 2 {T}_{PM} {T}_{D} + {T}_{PM}^{2} - {T}_{D}^{2} ) = - πΔ f ( 2 {T}_{D} + {T}_{PM} )$$

and the combined phase error is

$${Δϕ}_{2 WR} = {Δϕ}_{R} + {Δϕ}_{I} = - 2 πΔ {fT}_{D}$$

Given that both reflector and initiator before a phase measurement of duration T_{PM} and the initiator starts its phase measurement a time T_{P} later than the reflector, in this case a frequency offset will be

$${ψ}_{ir} ( f ) = - 2 π f ( \frac{d}{v} + Δ T ) + πΔ f \cdot {T}_{PM}$$

where T_{PM} is the duration of the phase measurement at the reflector and initiator, and

$${ψ}_{ir} ( f ) = - 2 π f ( \frac{d}{v} - Δ T ) - πΔ f ( 2 {T}_{D} + {T}_{PM} ) .$$

Thus, in this case

$$θ ( f ) = {ψ}_{ir} ( f ) - {ψ}_{ri} ( f ) = - 4 π f Δ T - 2 πΔ f ( {T}_{D} - {T}_{PM} )$$

When Δf is known, the term −2ππf(T_{D}+T_{PM}) may be removed. Methods of determining Δf comprises in one embodiment performing a precise frequency estimation over a long frequency estimation tone, and estimating the frequency offset, and calculating the FFO based on this. The estimate of the FFO may then be used to correct the values of θ(f). In another embodiment, the initiator may attempt to minimize the frequency offset by tuning it's local oscillator to the value expected from extrapolating the measured FFO.

It may then be assumed that the phase difference between the LOs 103, 113 is a function of the time difference between the first radio transceiver device 100 and the second radio transceiver device 110, e.g.

$${θ}_{i} ( n ) - {θ}_{r} ( n ) = 2 π ( {f}_{0} + n Δ f ) Δ T$$

Repeating that the signal received at the second radio transceiver device 110, i.e. the reflector, is given

$${y}_{r} ( n ) = {\sum }_{l = 1}^{L} h ( {d}_{l} ) exp j ( \frac{2 π ( {f}_{0} + n Δ f ) {d}_{l}}{v} ) exp j ( {θ}_{i} ( n ) - {θ}_{r} ( n ) + {ψ}_{ir , 0} ) + {v}_{r} ( n )$$

and the signal received at the first radio transceiver device 100, i.e. the initiator, is

$$given$$

$${y}_{i} ( n ) = {\sum }_{l = 1}^{L} h ( {d}_{l} ) exp j ( \frac{2 π ( {f}_{0} + n Δ f ) {d}_{l}}{v} ) exp j ( {θ}_{r} ( n ) - {θ}_{i} ( n ) + {ψ}_{ri} , 0 ) + {v}_{i} ( n )$$

$$then$$

$${y}_{r}^{*} ( n ) {y}_{i} ( n ) = exp j ( 2 ( {θ}_{r} ( n ) - {θ}_{i} ( n ) ) ) exp j ( {ψ}_{ir , 0} - {ψ}_{ir , 0} ) {\vert H ( {f}_{0} + n Δ f ) \vert}^{2} + noise terms$$

Meaning that the relative phase angle of yᵣ*(n)yᵢ(n) is given by

$${ψ}^{Δ T} ( n ) = ∠ {y}_{r}^{*} ( n ) {y}_{i} ( n ) = 4 π ( {f}_{0} + n Δ f ) Δ T + constant + noise terms$$

that as described above may be simplified to

$${ψ}^{Δ T} ( n ) = {mod [ 4 π ( {f}_{0} + n Δ f ) Δ T + {ψ}_{0} + ξ ( n ) ]}_{2 π}$$

Replacing the time-of-flight d/c with the time offset ΔT in the above equations gives α=2ΔfΔT and β=2f₀ΔT+ψ₀/2π

Using the same metrics as defined above with reference to the distance estimates, in step 605, the first radio transceiver device 100 creates a first set of time offset estimate candidates ΔT₁. Then in step 606, the first radio transceiver device, repeatedly for the set of measured phase difference values of N values of n plurality radio channels, determines an optimal phase unwrapping vector candidate based on the first set of time offset estimate candidates and the measured phase differences of signals received on the first and second transceiver device 100, 110, to determine second set of time offset candidates ΔT₂. Then in step 607, the time offset ΔT between the first radio transceiver device 100 and the second transceiver device 100 is calculated using the using the optimal phase unwrapping vector candidate and the second set of time offset candidates ΔT₂.

Using the time offset ΔT, the second radio frequency device 110, may solve for θᵢ(n)−θᵣ(n) obtaining

$${y}_{r} ( n ) = H ( {f}_{0} + n Δ f ) exp j ( 2 π ( {f}_{0} + n Δ f ) Δ T + {ψ}_{ir , 0} )$$

Then the second radio frequency device 110, in step 608, may determine the distance d between the first radio transceiver device 100 and the second transceiver device 100 by measuring the phase difference of the radio frequency signals on each radio channel received from the first radio transceiver device 100 on a superset, S, of the plurality of radio channels used to calculate the time offset. In one example, there may be N radio channels where tones are sent in two directions, i.e. 2-way radio channels, and L radio channels where tones are sent in one direction, i.e. 1-way channels. Up to and including N channels may then be used to calculate the time offset. Up to and including L+N channels may be used to determine the distance. Thus, in this example, the superset S may comprise up to and including L+N radio channels. Any suitable subset of the superset of L+N may be used to determine the distance, d. In one example, the plurality of radio channels may be a subset, N, of a frequency band comprising of uniformly spaced radio channels. The frequency band may for example comprise of 75 radio frequencies uniformly spaced at 1 MHz or 37 radio frequencies spaced at 2 MHz. The subset, N, may in one embodiment comprise of 5 to 10 radio channels. The superset, S, of the plurality of radio channels used to calculate the time offset may in one embodiment comprise all or a subset of the radio channels of the frequency band comprising of uniformly spaced radio channels.

In the preceding description, various aspects of the method and radio frequency transceiver device according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the method and image processing device, which are apparent to persons skilled in the art to which the disclosed subject matter pertains, are deemed to lie within the scope of the present invention.

1. A method for determining a distance between a first radio transceiver device and a second radio transceiver device, the method comprising:
sequentially transmitting, from the first radio transceiver device to the second radio transceiver device, radio frequency signals on a plurality of radio channels, each channel being non-uniformly spaced and representing a distinct continuous tone,
sequentially transmitting, from the second radio transceiver device to the first radio transceiver device, radio frequency signals with distinct continuous tones on same channels as those received from the first radio transceiver device, as well as measured phase difference of the radio frequency signals on each radio channel received from the first radio transceiver device,
on the first radio transceiver device,
creating a first set of estimate candidates,
repeatedly for the plurality radio channels, determining an optimal phase unwrapping vector candidate based on the first set of estimate candidates and the measured phase differences of signals received on the first and the second transceiver devices to determine a second set of candidates, and
calculating the distance between the first radio transceiver device and the second radio transceiver device using the optimal phase unwrapping vector candidate and the second set of candidates.

2. The method of claim 1, wherein the plurality of radio channels is a subset of a frequency band comprising of uniformly spaced radio channels.

3. The method of claim 1, wherein the first set of estimate candidates and the second set of candidates comprises candidates of the distance between the first radio transceiver device and the second transceiver device.

4. The method of claim 1, wherein the first set of estimate candidates and the second set of candidates comprises candidates of a time offset between the first radio transceiver device and the second transceiver device, the step of calculating the distance between the first radio transceiver device and the second radio transceiver device further comprising:
calculating the time offset between the first radio transceiver device and the second transceiver device using the optimal phase unwrapping vector candidate and the second set of time offset candidates, and
on the second radio transceiver device, determining the distance between the first radio transceiver device and the second transceiver device by measuring the phase difference of the radio frequency signals on each radio channel received from the second radio transceiver device on a superset of the plurality of radio channels used to calculate the time offset.

5. The method of claim 2, wherein the superset of the plurality of radio channels used to calculate the time offset comprises the frequency band comprising of uniformly spaced radio channels.

6. The method of claim 2, wherein the frequency band comprises 75 radio frequencies uniformly spaced at 1 MHz or 37 radio frequencies spaced at 2 MHz.

7. A radio frequency transceiver device arranged to
sequentially transmit radio frequency signals on a plurality of radio channels, each channel being non-uniformly spaced and representing a distinct continuous tone,
sequentially receive from a second radio transceiver device, radio frequency signals with distinct continuous tones on same channels as those transmitted from the first radio transceiver device, as well as measured phase difference of the radio frequency signals on each radio channel transmitted from the first radio transceiver device,
create a first set of estimate candidates,
repeatedly for the plurality of radio channels, determine an optimal phase unwrapping vector candidate based on the first set of estimate candidates and the measured phase differences of signals received on the first and the second transceiver devices to determine a second set of candidates, and
calculate the distance between the first radio transceiver device and the second radio transceiver device using the optimal phase unwrapping vector candidate and the second set of candidates.

8. The radio frequency transceiver device of claim 7, wherein the plurality of radio channels is a subset of a frequency band comprising of uniformly spaced radio channels.

9. The radio frequency transceiver device of claim 7, wherein the first set of estimate candidates and the second set of candidates comprises candidates of the distance between the first radio transceiver device and the second transceiver device.

10. The radio frequency transceiver device of claim 7, wherein the first set of estimate candidates and the second set of candidates comprises candidates of a time offset between the first radio transceiver device and the second transceiver device, the step of calculating the distance between the first radio transceiver device and the second radio transceiver device further comprising:
calculating the time offset between the first radio transceiver device and the second transceiver device using the optimal phase unwrapping vector candidate and the second set of time offset candidates, and
on the second radio transceiver device, determining the distance between the first radio transceiver device and the second transceiver device by measuring the phase difference of the radio frequency signals on each radio channel received from the second radio transceiver device on a superset of the plurality of radio channels used to calculate the time offset.

11. The radio frequency transceiver device of claim 8, wherein the superset of the plurality of radio channels used to calculate the time offset comprises the frequency band comprising of uniformly spaced radio channels.

12. The radio frequency transceiver device of claim 8, wherein the frequency band comprises 75 radio frequencies uniformly spaced at 1 MHz or 37 radio frequencies spaced at 2 MHz.

13. The method of claim 4, wherein the superset of the plurality of radio channels used to calculate the time offset comprises the frequency band comprising of uniformly spaced radio channels.

14. The radio frequency transceiver device of claim 10, wherein the superset of the plurality of radio channels used to calculate the time offset comprises the frequency band comprising of uniformly spaced radio channels.
